(19) United States
(12) Patent Application Publication
(10) Pub. No.: US 2026/0338427 A1
(43) Pub. Date: Oct. 29, 2026

(54) INVERTER-INTEGRATED ELECTRIC COMPRESSOR AND METHOD FOR MANUFACTURING SAME

(71) Applicant: SANDEN CORPORATION, Gunma (JP)

(72) Inventors: Takafumi AKUTSU, Gunma (JP); Koji FUJISHIRO, Gunma (JP)

(21) Appl. No.: 19/107,280

(22) PCT Filed: Aug. 29, 2023
(86) PCT No.: PCT/JP2023/031300

§ 371 Date: Feb. 27, 2025

(30) Foreign Application Priority Data
Sep. 16, 2022 (JP) 2022-147719

(51) Int. Cl. F25B 31/02; F04C 18/02

(52) U.S. Cl. CPC F25B 31/02; F04C 18/0207; F04C 2240/30; F04C 2240/40; F25B 2500/12; F25B 2600/021

(57) ABSTRACT

An inverter-integrated electric compressor comprising a cover 15 that closes an inverter accommodating portion 13. The cover 15 includes a sheet metal having a shell-shaped upper wall portion 41, a vertical wall portion 42 continuously formed on an outer periphery of the upper wall portion, and a seal flange portion 46 continuously projecting outward from an outer periphery of the vertical wall portion and attached to a housing 11. By adjusting the curvature radius of the arch constituting a shell shape of the upper wall portion and the angle at which the vertical wall portion rises from the seal flange portion, the natural frequency of the cover is shifted from the resonance point with the vibromotive force of a compression mechanism 4 and an electric motor 2.

### TECHNICAL FIELD

The present invention relates to an inverter-integrated electric compressor including a cover that closes an inverter accommodating portion formed in a housing, and a method for manufacturing the same.

### BACKGROUND ART

Heretofore, in an inverter-integrated electric compressor of this type, specifically an electric compressor constituting an air conditioner of a vehicle, an inverter is accommodated and fixed in an inverter accommodating portion (inverter case) formed in a metal housing, and the inverter accommodating portion is closed by a cover. Here, since the cover is not necessarily pressure-resistant, the cover is usually formed of an aluminum die-cast thin plate, but when vibration of the compression mechanism and the motor in the housing is transmitted to the cover, the vibration is generated to produce noise.

In this case, when the frequency of the vibromotive force of the compression mechanism or the motor matches or approximates the natural frequency of the cover, resonance occurs, and there is a problem that vibration and noise increase. Therefore, there has been proposed an electric compressor in which a groove is formed in a cover to shift a natural frequency of the cover from resonance (see, for example, Patent Literature 1.)

### CITATION LIST

### Patent Literature

Patent Literature 1: Japanese U.S. Pat. No. 5,510,490

### SUMMARY OF INVENTION

### Problems to be Solved by Invention

However, it is difficult to reduce the weight by forming the shape as in Patent Literature 1 by aluminum die casting, and it is difficult to make the thickness thicker because the height dimension becomes large. Therefore, it is difficult to make a compact design. Furthermore, in the case of aluminum die casting, a large number of steps are required, such as casting (die casting) an aluminum ingot, then removing distortion by heat treatment, and performing cutting machining, and the amount of carbon dioxide discharged increases, making it difficult to cope with carbon neutral. Furthermore, the configuration of Patent Literature 1 has a problem that the natural frequency can be shifted only in a low direction.

The present invention has been made to solve technical problems in the related art, and an object of the present invention is to provide an inverter-integrated electric compressor capable of suppressing vibration and noise due to resonance while reducing the weight and production cost of a cover that closes an inverter accommodating portion, and a method for manufacturing the same.

### Solution to Problems

An inverter-integrated electric compressor of the present invention includes: a metal housing in which a motor and a compression mechanism are built; an inverter that drives the motor; an inverter accommodating portion formed in the housing and accommodating the inverter; and a metal cover that closes the inverter accommodating portion, in which the cover is formed of a sheet metal having a shell-shaped upper wall portion, a vertical wall portion continuously formed on an outer periphery of the upper wall portion, and a seal flange portion continuously projecting outward from an outer periphery of the vertical wall portion and attached to the housing, and a natural frequency of the cover is shifted from a resonance point with vibromotive force of the compression mechanism and the motor by adjusting a curvature radius of an arch constituting the shell shape of the upper wall portion and/or an angle at which the vertical wall portion rises from the seal flange portion.

In an inverter-integrated electric compressor of an invention according to claim 2, the curvature radius of the arch of the cover is set to a different value in a longitudinal direction and a lateral direction.

In an inverter-integrated electric compressor of an invention according to claim 3, the curvature radius in the longitudinal direction of the arch of the cover is larger than the curvature radius in the lateral direction.

In an inverter-integrated electric compressor of an invention according to claim 4, the shell shape of the cover in the invention according to claim I includes a plurality of arches having different radii of curvature.

In an inverter-integrated electric compressor of an invention according to claim 5, an angle at which the vertical wall portion rises from the seal flange portion is an angle of 30° or more and an angle of 75° or less.

In an inverter-integrated electric compressor of an invention according to claim 6, a height dimension of the cover in the invention according to claims 1 to 4 is 8 mm or more and 20 mm or less.

A method for manufacturing an inverter-integrated electric compressor according to claim 7, the method including: manufacturing an inverter-integrated electric compressor including a metal housing in which a motor and a compression mechanism are built, an inverter that drives the motor, an inverter accommodating portion formed in the housing and accommodating the inverter, and a metal cover that closes the inverter accommodating portion, in which the cover is formed of a sheet metal having a shell-shaped upper wall portion, a vertical wall portion continuously formed on an outer periphery of the upper wall portion, and a seal flange portion continuously extending outward from an outer periphery of the vertical wall portion and attached to the housing, and a natural frequency of the cover is shifted from a resonance point with vibromotive force of the compression mechanism and the motor by adjusting a curvature radius of an arch constituting the shell shape of the upper wall portion and/or an angle at which the vertical wall portion rises from the seal flange portion.

### Effects of Invention

According to the inventions of claims 1 to 7, in the inverter-integrated electric compressor including the metal housing in which the motor and the compression mechanism are built, the inverter that drives the motor, the inverter accommodating portion which is formed in the housing and accommodates the inverter, and the metal cover which closes the inverter accommodating portion, the cover is formed of the sheet metal having a shell-shaped upper wall portion, the vertical wall portion continuously formed on the outer periphery of the upper wall portion, and the seal flange portion continuously projecting outward from the outer periphery of the vertical wall portion and attached to the housing, and a natural frequency of the cover is shifted from a resonance point with vibromotive force of the compression mechanism and the motor by adjusting the curvature radius of the arch constituting the shell shape of the upper wall portion and/or the angle at which the vertical wall portion rises from the seal flange portion. Thus, it is possible to suppress inconvenience that the cover resonates due to vibration of the compression mechanism or the motor.

As a result, it possible to significantly reduce vibration and noise due to resonance. Specifically, since the cover is made of a sheet metal, the cover can be manufactured by press machining of a steel plate as compared with aluminum die casting, and the number of steps is reduced to save energy, and thus it is possible to greatly reduce the carbon dioxide emission amount to contribute to environmental problems, and it is also possible to reduce the production cost. In addition, in aluminum die casting, the natural frequency is shifted by changing the thickness.

However, in the present invention, it is possible to shift the natural frequency by forming a sheet metal having a substantially constant sheet thickness, and thus, it is possible to reduce the weight and improve the performance of a vehicle when used for an air conditioner of the vehicle. Furthermore, by forming the upper wall portion of the sheet metal cover in a shell shape and further forming the vertical wall portion and the seal flange portion on its outer periphery, there is an effect of improving the strength of the cover itself.

In this case, by setting the curvature radius of the arch of the cover to be different between the longitudinal direction and the lateral direction as in the invention according to claim 2, it is possible to expand the adjustment range of the natural frequency of the cover.

Specifically, as in the invention according to claim 3, by making the curvature radius of the arch of the cover in the longitudinal direction larger than the curvature radius in the lateral direction, it is possible to suppress an increase in the height dimension of the cover and to suppress an increase in the dimension of the entire electric compressor.

In addition, even when the shell shape of the cover is formed of a plurality of arches having different curvature radii as in the invention according to claim 4, it is possible to suppress an increase in the height dimension of the cover and to suppress an increase in the dimension of the entire electric compressor.

Further, as in the invention according to claim 5, by adjusting the angle at which the vertical wall portion rises from the seal flange portion in the range of an angle of 30° or more and an angle of 75° or less, it is possible to effectively shift the natural frequency of the cover from the resonance point.

In addition, as in the invention according to claim 6, by setting the height dimension of the cover to a range of 8 mm or more and 20 mm or less, it is possible to effectively shift the natural frequency from the resonance point by adjusting the second moment of area of the cover.

### BRIEF DESCRIPTION OF DRAWINGS

FIG. 1 is a schematic cross-sectional view of an inverter-integrated electric compressor according to an embodiment to which the present invention is applied (Example 1).

FIG. 2 is a plan view of a cover that closes an inverter accommodating portion of the electric compressor in FIG. 1.

FIG. 3 is a longitudinal side view of the cover of FIG. 2.

FIG. 4 is a lateral side view of the cover of FIG. 2.

FIG. 5 is a rear view of the cover of FIG. 2.

FIG. 6 is a cross-sectional view taken along line C-C in FIG. 2.

FIG. 7 is a cross-sectional view taken along line B-B in FIG. 5.

FIG. 8 is a plan view of a cover according to another example that closes an inverter accommodating portion of an electric compressor (Example 2).

FIG. 9 is a longitudinal side view of the cover of FIG. 8.

FIG. 10 is a lateral side view of the cover of FIG. 8.

FIG. 11 is a rear view of the cover of FIG. 8.

FIG. 12 is a cross-sectional view of the cover of FIG. 8 taken along line D-D.

FIG. 13 is a cross-sectional view of the cover of FIG. 8 taken along line E-E.

FIG. 14 is a cross-sectional view of the cover of FIG. 8 taken along line F-F.

### DESCRIPTION OF EMBODIMENTS

In the following, embodiments of the present invention will be described in detail with reference to the drawings.

### EXAMPLE 1

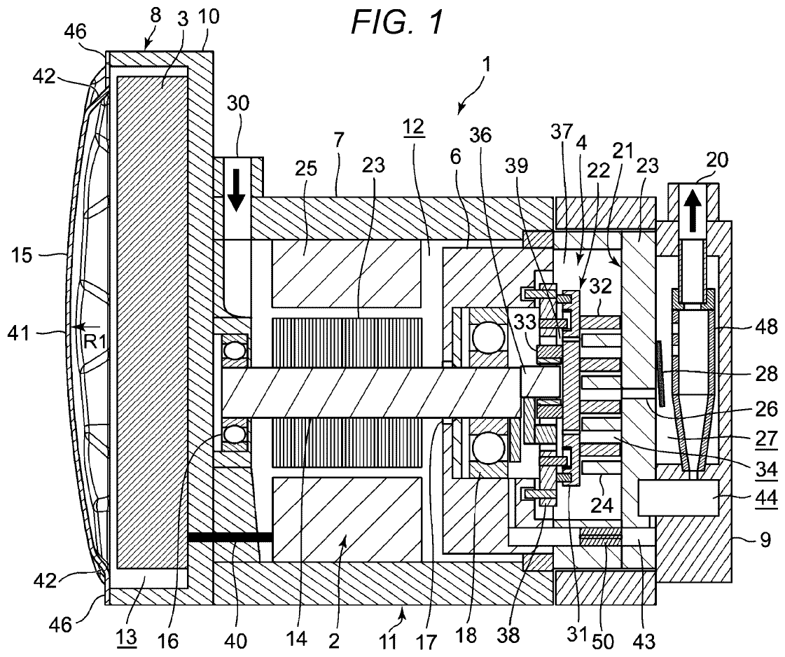

FIG. 1 is a schematic cross-sectional view of an inverter-integrated electric compressor I according to an example to which the present invention is applied. The electric compressor (inverter-integrated electric compressor) 1 of the example is used, for example, in a refrigerant circuit constituting an air conditioner for an electric vehicle, and sucks, compresses, and discharges a refrigerant as a working fluid of the air conditioner to a discharge pipe. The electric compressor I is a so-called horizontal inverter-integrated scroll electric compressor including a three-phase electric motor 2 as a motor in the present invention, an inverter 3 that operates the electric motor 2, and a scroll compression mechanism 4 as a compression mechanism driven by the electric motor 2.

In the case of the example, the electric compressor 1 includes a cylindrical stator housing 7 that accommodates the electric motor 2 and the center plate 6 inside, an inverter case 8 that is attached to an end wall 7A on one end side of the stator housing 7 and accommodates the inverter 3 inside, and a rear casing 9 that is attached to an open end surface on the other end side of the stator housing 7.

All of the stator housing 7, the inverter case 8, and the rear casing 9 are made of metal (made of aluminum in the example, and except a cover 15 described later), and these components are integrally joined to form a housing 11 of the electric compressor 1 of the example.

In the stator housing 7, a motor chamber 12 that accommodates the electric motor 2 is formed, and one end surface of the motor chamber 12 is basically closed by the end wall 7A of the stator housing 7. The other end surface of the motor chamber 12 of the stator housing 7 is opened, and the electric motor 2 is accommodated in the motor chamber 12 from the opening, and then the center plate 6 is accommodated from the opening. In addition, a sub bearing 16 that rotatably supports one end portion of the drive shaft 14 of the electric motor 2 is attached to the inner surface (motor chamber 12 side) of the end wall 7A.

The center plate 6 has an opening on the side opposite to the electric motor 2 (the other end side). After a movable scroll 22 of the scroll compression mechanism 4 is accommodated in the opening, the rear casing 9 to which the fixed scroll 21 of the scroll compression mechanism 4 is fixed is fixed to the opening of the stator housing 7 to close the opening.

In addition, a through hole 17 through which the other end portion of the drive shaft 14 of the electric motor 2 is inserted is opened in the center plate 6, and a main bearing 18 that rotatably supports the other end portion of the drive shaft 14 on the scroll compression mechanism 4 side is attached in the center plate 6 on the scroll compression mechanism 4 side of the through hole 17.

The electric motor 2 includes a stator around which a coil is wound and which is fixed to the inner side of the peripheral wall of the stator housing 7, and a rotor 23 which rotates inside the stator 25. Then, for example, a direct current from a battery (not shown) of the vehicle is converted into a three-phase alternating current by the inverter 3, and power is supplied to the coil of the stator 25 of the electric motor 2, and thus the rotor 23 is rotationally driven. The drive shaft 14 is fixed to the rotor 23.

In addition, a suction port 30 is formed in the stator housing 7, and the refrigerant sucked from the suction port 30 passes through the motor chamber 12 of the stator housing 7, then flows into the center plate 6, and is sucked into a suction portion 37 outside the scroll compression mechanism 4. As a result, the electric motor 2 is cooled by the suction refrigerant. In addition, the refrigerant compressed by the scroll compression mechanism 4 is discharged from a discharge chamber 27 to be described later to a discharge pipe of a refrigerant circuit (not shown) outside the housing 11 through a discharge port 20 formed in the rear casing 9.

The scroll compression mechanism 4 includes the fixed scroll 21 and the movable scroll 22 described above. The fixed scroll 21 integrally includes a disk-shaped end plate 23 and a spiral wrap 24 having an involute shape or a curved shape similar to the involute shape and erected on a surface (one surface) of the end plate 23, and is fixed to the rear casing 9 with the surface of the end plate 23 on which the wrap 24 is erected as the center plate 6 side. In the center of the end plate 23 of the fixed scroll 21, a discharge hole 26 is formed, and the discharge hole 26 communicates with the discharge chamber 27 in the rear casing 9. In the drawing, a reference sign 28 denotes a discharge valve provided at an opening of the discharge hole 26 on the back (the other surface) side of the end plate 23.

The movable scroll 22 is a scroll that revolves relative to the fixed scroll 21, and integrally includes a disk-shaped end plate 31, a wrap 32 erected on a surface (one surface) of the end plate 31, the wrap 32 having an involute shape or a spiral shape formed of a curve closer to the involute shape, and a boss 33 protruding from the center of the back (the other surface) of the end plate 31. The movable scroll 22 is disposed in such a manner that the wrap 32 faces and meshes with the wrap 24 of the fixed scroll 21 with the protruding direction of the wrap 32 facing the fixed scroll 21, and a pressure chamber 34 is formed between the wraps 24 and 32.

In other words, the wrap 32 of the movable scroll 22 faces the wrap 24 of the fixed scroll 21, and meshes with the wrap 24 of the fixed scroll 21 in such a manner that the tip end of the wrap 32 is in contact with the surface of the end plate 23 and the tip end of the wrap 24 is in contact with the surface of the end plate 31, and an eccentric portion 36 that is provided at the other end of the drive shaft 14 in such a manner as to be eccentric to the axis is fitted in the boss 33 of the movable scroll 22. In addition, it is configured in such a manner that when the drive shaft 14 is rotated together with the rotor 23 of the electric motor 2, the movable scroll 22 performs revolution motion relative to the fixed scroll 21 without rotating on its axis.

Since the movable scroll 22 is eccentric with respect to the fixed scroll 21 and revolves, the wraps 24 and 32 move while rotating in the eccentric direction and the contact position, and the pressure chamber 34 that sucks the refrigerant from the suction portion 37 on the outer side gradually decreases while moving inward. As a result, the refrigerant is compressed and finally discharged from the central discharge hole 26 to the discharge chamber 27 via the discharge valve 28.

In FIG. 1, a reference sign 38 denotes an annular thrust plate. The thrust plate 38 is provided for partitioning a back pressure chamber 39 formed between the back surface of the end plate 31 of the movable scroll 22 and the center plate 6 and the suction portion 37 outside the scroll compression mechanism 4, and is located outside the boss 33 and interposed between the center plate 6 and the movable scroll 22.

In addition, a reference sign 48 denotes a centrifugal oil separator attached to the discharge chamber 27 of the rear casing 9 (housing 11). The oil separator 48 separates lubricating oil mixed in the refrigerant discharged from the scroll compression mechanism 4 to the discharge chamber 27, and the refrigerant flows toward the discharge port 20 and is discharged to the discharge pipe.

The rear casing 9 is formed with an oil reservoir chamber 44 below the oil separator 48, and the oil separated from the refrigerant by the oil separator 48 flows into the oil reservoir chamber 44 from a lower end of the oil separator 48. In the drawing, a reference sign 43 denotes a back pressure path formed from the rear casing 9 to the center plate 6, and has an orifice 50. The discharge pressure adjusted to reduce the pressure by the orifice 50 of the back pressure path 43 is supplied to the back pressure chamber 39 together with the oil in the oil reservoir chamber 44 separated by the oil separator 48.

The pressure (back pressure) in the back pressure chamber 39 generates a back pressure load that presses the movable scroll 22 against the fixed scroll 21. Under the back pressure load, the movable scroll 22 is pressed against the fixed scroll 21 against the compression reaction force from the pressure chamber 34 of the scroll compression mechanism 4, the contact between the wraps 24 and 32 and the end plates 31 and 23 is maintained, and the refrigerant can be compressed in the pressure chamber 34.

On the other hand, the inverter case 8 includes a case main body 10 constituting an inverter accommodating portion 13 inside, and the cover 15 of the present invention that closes an opening on one end surface of the case main body 10.

Then, the inverter 3 is accommodated in the inverter accommodating portion 13, and the cover 15 is attached to the case main body 10 after the inverter 3 is accommodated in the inverter accommodating portion 13.

In FIG. 1, a reference sign 40 denotes a hermetic pin. The hermetic pin 40 penetrates the partition wall 7A, has one end connected to the coil of the stator 25 of the electric motor 2 accommodated in the motor chamber 12, and has the other end electrically connected to the inverter 3 accommodated in the inverter accommodating portion 13.

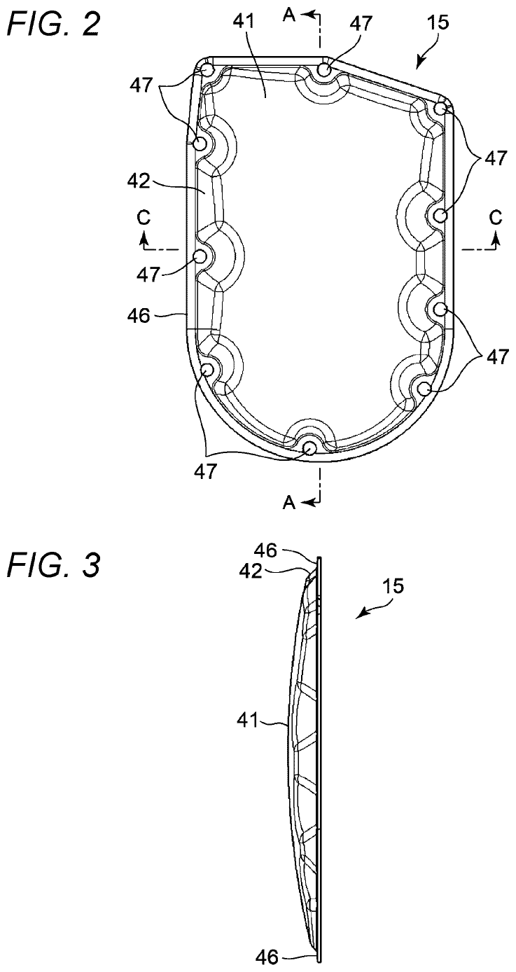

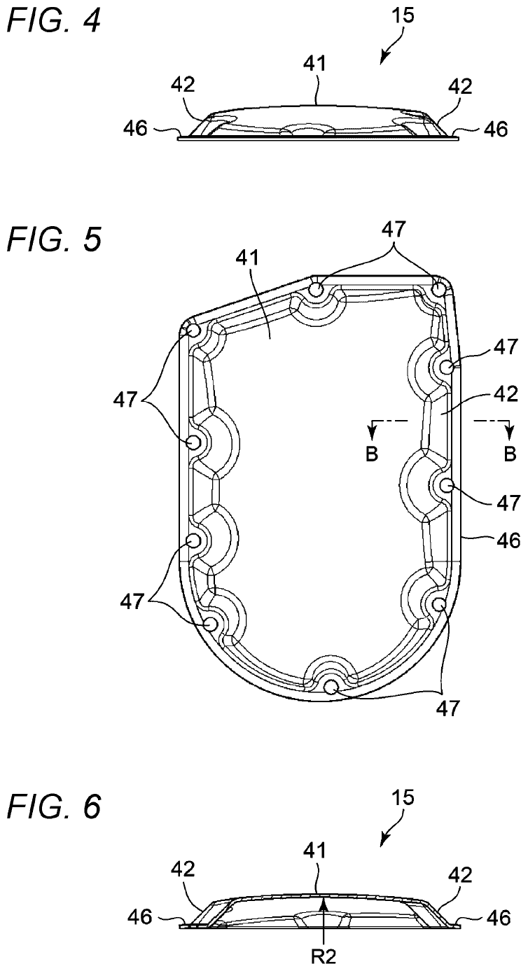

Next, the shape of the cover 15 of the example will be described with reference to FIGS. 2 to 7. Note that a cross section of the cover 15 in FIG. 1 is a cross section taken along line A-A in FIG. 2. The cover 15 used in the present invention is formed by press machining (without cutting) a sheet metal made of a surface-treated steel sheet and having a predetermined thin thickness dimension. The cover 15 includes a shell-shaped upper wall portion 41 as shown in each drawing including FIG. 1, a vertical wall portion 42 continuously formed on the outer periphery of the upper wall portion 41, and a seal flange portion 46 continuously projecting outward from the outer periphery of a vertical wall portion 42.

Note that a reference sign 47 denotes a bolt hole formed in the seal flange portion 46. Then, the seal flange portion 46 is attached to the open end surface of the case main body 10 as shown in FIG. 1, and a bolt (not shown) is inserted into the bolt hole 47 and screwed into the case main body 10, and thus the cover 15 is attached to the case main body 10.

In the upper wall portion 41 of the cover 15 having a shell shape, a curvature radius RI (FIG. 1) of the arch in the longitudinal direction is different from a curvature radius R2 (FIG. 6) in the lateral direction, and RI >R2 (the curvature radius R1 of the arch in the longitudinal direction is larger than the curvature radius R2 in the lateral direction). That is, for example, the curvature radius RI in the longitudinal direction is set to 430 mm, and the curvature radius R2 in the lateral direction is set to 405 mm. In addition, the height dimension of the cover 15 is set to a range of 8 mm or more and 20 mm or less, and 17 mm in the example correspondingly.

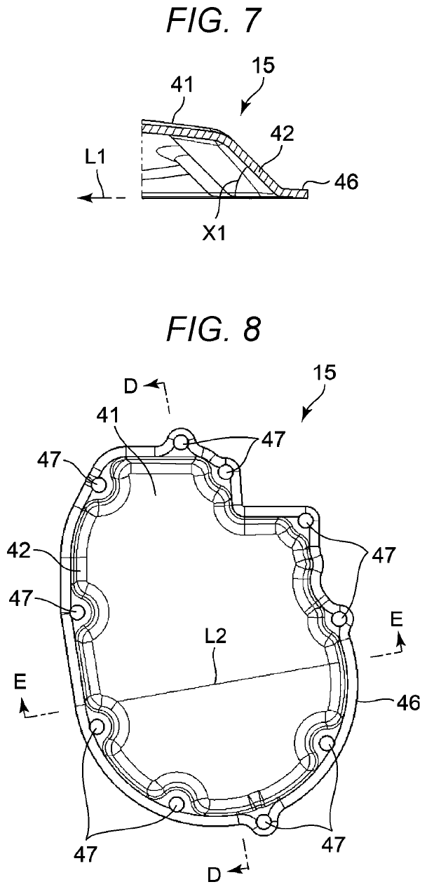

Further, an angle X1 at which the vertical wall portion 42 rises from the seal flange portion 46 is set to a range of an angle of 30°or more and an angle of 75° or less, and an angle of 45° in the example. Note that in the present application, the rising angle XI is defined as an angle formed by line LI extending inward from the seal flange portion 46 and the vertical wall portion 42 as shown in FIG. 7.

Here, when the curvature radii RI and R2 of the arch of the shell-shaped upper wall portion 41 are increased, the natural frequency of the cover 15 is decreased, and when the curvature radii RI and R2 are decreased, the natural frequency is increased. In addition, when the rising angle XI of the vertical wall portion 42 is reduced, the connection to the upper wall portion 41 becomes smooth, and thus the natural frequency of the cover 15 becomes high, and when the rising angle XI is increased, the natural frequency becomes low.

Therefore, in the example, by adjusting the curvature radius RI of the arch in the longitudinal direction of the upper wall portion 41 of the cover 15, the curvature radius R2 of the arch in the lateral direction, and the rising angle X1 of the vertical wall portion 42, the natural frequency (mainly the primary natural frequency) of the cover 15 is designed to shift from the frequencies of the vibromotive forces of the compression mechanism 4 and the electric motor 2, which become the vibration source of the electric compressor 1. That is, the natural frequency of the cover 15 is shifted from the resonance point with the vibromotive forces of the compression mechanism 4 and the electric motor 2.

Note that since the frequency of the vibromotive force of the compression mechanism 4 and the electric motor 2 changes depending on the operation state, in the example, the natural frequency of the cover 15 is set to be higher than the range of the frequency of the vibromotive force (the frequency range of the vibromotive force generated in the operation state from the low speed to the high speed). For example, assuming that the frequency range of the vibromotive forces of the compression mechanism 4 and the electric motor 2 is 1,100 Hz to 2,000 Hz, the curvature radii RI and R2 and the rising angle XI are adjusted such that the natural frequency of the cover 15 becomes 2,100 Hz.

As a result, it is possible to suppress inconvenience that the cover 15 resonates due to vibration of the compression mechanism 4 and the electric motor 2, and it is possible to greatly reduce vibration and noise due to resonance of the cover 15. Specifically, since the cover 15 is made of a sheet metal, it can be manufactured by press machining of a surface-treated steel sheet as compared with aluminum die casting, and the number of steps is reduced to save energy, and thus it is also possible to significantly reduce the production cost and the carbon dioxide emission amount. In addition, in aluminum die casting, the natural frequency is shifted by changing the thickness. However, in the present invention, the natural frequency of cover letter 15 can be shifted by forming a sheet metal having a substantially constant thickness, and the weight can be significantly reduced as well. Furthermore, by forming the upper wall portion 41 of the cover 15 made of sheet metal in a shell shape and further forming the vertical wall portion 42 and the seal flange portion 46 on the outer periphery, the strength of the cover 15 itself is also improved, and deformation due to collision is also suppressed.

In addition, when the curvature radius of the arch of the cover 15 is set to a different value in the longitudinal direction (RI) and the lateral direction (R2) as in the example, it is possible to expand the adjustment range of the natural frequency of the cover 15. Specifically, as in the example, by making the curvature radius R1 of the arch of the cover 15 in the longitudinal direction larger than the curvature radius R2 in the lateral direction, it is possible to suppress an increase in the height dimension of the cover 15 and to suppress an increase in the dimension of the entire electric compressor 1.

Furthermore, by adjusting the angle XI at which the vertical wall portion 42 rises from the seal flange portion 46 in the range of an angle of 30° or more and an angle of 75° or less, the natural frequency of the cover 15 can be smoothly shifted from the resonance point. In addition, by setting the height dimension of the cover 15 to a range of 8 mm or more and 20 mm or less as in the example, it is possible to effectively shift the natural frequency from the resonance point by earning the second moment of area of the cover 15.

### EXAMPLE 2

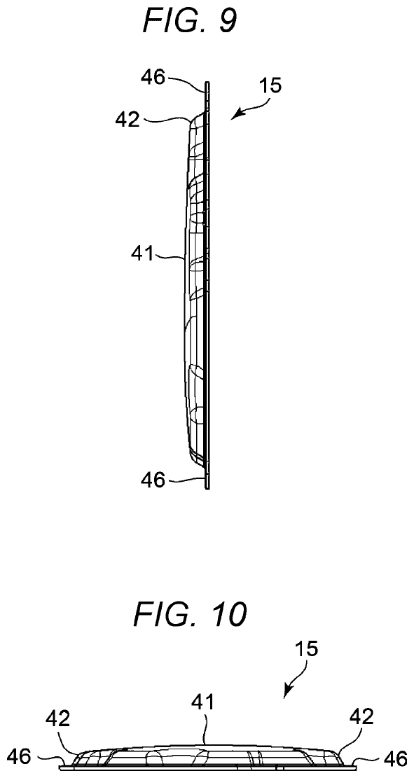

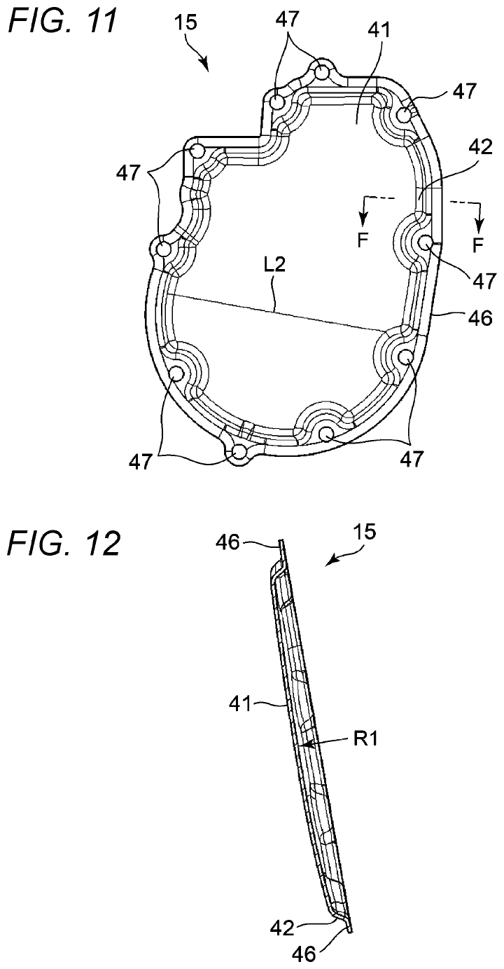

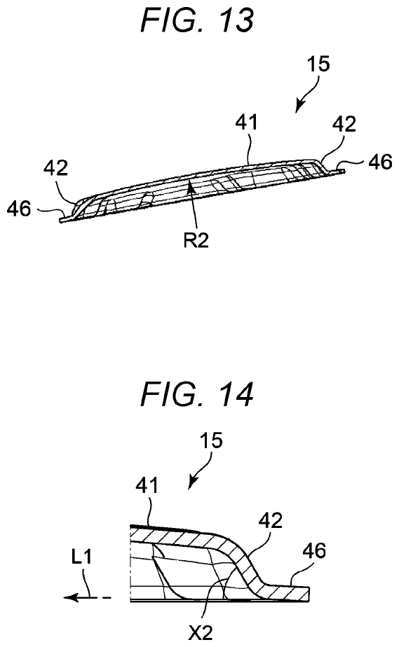

Next, another example of the present invention will be described with reference to FIGS. 8 to 14. Note that in each drawing, components denoted by the same a reference signs as those in FIGS. 1 to 7 have the same or similar functions. In the case of the example, in an upper wall portion 41 of a cover 15, a curvature radius R1 (FIG. 12) of an arch in the longitudinal direction on one side (lower side in FIG. 8) of line L2 in FIG. 8 is the same as a curvature radius R2 (FIG. 13) in the lateral direction, and on the other side (upper side in FIG. 8) of line L2, the curvature radius R1 of the arch in the longitudinal direction and the curvature radius R2 in the lateral direction are different from each other, and the relationship of R1>R2 is established (the curvature radius RI of the arch in the longitudinal direction is larger than the curvature radius R2 in the lateral direction).

Note that line L2 in FIG. 8 is located on the axis of a drive shaft 14 or in its vicinity in a state where the cover 15 is attached to a case main body 10. That is, in the case of the example, for example, both the curvature radius R1 in the longitudinal direction and the curvature radius R2 in the lateral direction are set to 510 mm below line L2, and for example, the curvature radius R1 in the longitudinal direction is set to 1,900 mm and the curvature radius R2 in the lateral direction is set to 510 mm above line L2. Note that it is effective that the curvature radii R1 and R2 are 300 mm or more and 2,000 mm or less.

As described above, in the longitudinal direction of the cover 15 of the example, the curvature radius R1 of the arch is made different between the lower side and the upper side of line L2. This is a synthetic shape of a rotational curved surface and a paraboloid. In addition, the height dimension of the cover 15 is set to a range of 8 mm or more and 20 mm or less, and 11 mm in the example correspondingly.

Furthermore, in the present example, the angle X1 at which a vertical wall portion 42 rises from a seal flange portion 46 is set to a range of an angle of 30° or more and an angle of 75° or less, and an angle of 60° in the example. Note that also in the example, the rising angle X1 is defined as an angle formed by line L1 extending inward from the seal flange portion 46 and the vertical wall portion 42 as shown in FIG. 14.

Also in the example, by adjusting the curvature radius R1 of the arch in the longitudinal direction of the upper wall portion 41 of the cover 15, the curvature radius R2 of the arch in the lateral direction, and the rising angle X1 of the vertical wall portion 42, the natural frequency (mainly the primary natural frequency) of the cover 15 is designed to shift from the frequencies of the vibromotive forces of a compression mechanism 4 and an electric motor 2, which are the vibration sources of an electric compressor 1. That is, the natural frequency of the cover 15 is shifted from the resonance point with the vibromotive forces of the compression mechanism 4 and the electric motor 2.

That is, also in the example, the natural frequency of the cover 15 is set to be higher than the frequency range of the vibromotive force of the compression mechanism 4 and the electric motor 2. For example, assuming that the frequency ranges of the vibromotive forces of the compression mechanism 4 and the electric motor 2 are 1,100 Hz to 2,000 Hz described above, the curvature radii R1 and R2 and the rising angle X1 are adjusted such that the natural frequency of the cover 15 becomes 2,200 Hz, and thus the inconvenience that the cover 15 resonates due to the vibration of the compression mechanism 4 and the electric motor 2 is suppressed, and the vibration and noise caused by the resonance of the cover 15 are greatly reduced.

Specifically, as in the example, by setting the curvature radius R1 of the arch of the shell-shaped cover 15 in the longitudinal direction to two different curvature radii R1 (510 mm and 1,900 mm in the example) with line L2 as a boundary, it is possible to suppress an increase in the height dimension of the cover 15 and to suppress an increase in the dimension of the entire electric compressor 1 as compared with the case where the entire length is 510 mm. In addition, the vertical wall portion 42 in the longitudinal direction is left, and it is possible to maintain the sealability with the inverter case 8 at that portion.

Note that in each of the above examples, both the curvature radii R1 and R2 of the arch of the upper wall portion 41 of the cover 15 and the rising angle X1 of the vertical wall portion 42 are adjusted, but the natural frequency of the cover 15 may be shifted from the resonance point with the vibromotive forces of the compression mechanism 4 and the electric motor 2 by adjusting only one of the curvature radii R1 and R2 and the rising angle X1.

In addition, in the examples, the natural frequency of the cover 15 is set to be higher than the range of the frequency of the vibromotive force of the compression mechanism 4 and the electric motor 2, but the present invention is not limited thereto, and the natural frequency may be set to be lower. Even in this case, although temporary resonance occurs at the time of starting/stopping, it is possible to suppress the occurrence of resonance as a whole.

Furthermore, in Example 2 described above, the synthetic shape of the rotational curved surface and the paraboloid surface has been described. However, when the shell shape of the cover 15 is formed of a plurality of arches having different curvature radii, a plurality of spherical shells may be independently constructed on the upper wall portion 41, and they may be smoothly joined by a curved surface such as a hyperbolic paraboloid surface or a cylindrical curved surface.

Furthermore, in the example, the scroll type electric compressor has been described as an example, but the present invention is also applicable to other compression type inverter-integrated electric compressors. Furthermore, the shapes and numerical values shown in the respective examples are not limited to the examples, and it is without saying that various modifications can be made without deviating from the gist of the present invention.

### LIST OF REFERENCE SIGNS

1 Inverter-integrated electric compressor
2 Electric motor (motor)
3 Inverter
4 Scroll compression mechanism (compression mechanism)
7 Stator housing
8 inverter case
10 case main body
11 Housing
13 inverter accommodating portion
15 Cover
41 Upper wall portion
42 Vertical wall portion
46 Seal flange portion

1. An inverter-integrated electric compressor comprising: a metal housing in which a motor and a compression mechanism are built; an inverter that drives the motor; an inverter accommodating portion that is formed in the housing and accommodates the inverter;
and a metal cover that closes the inverter accommodating portion, wherein the cover is formed of a sheet metal having a shell-shaped upper wall portion, a vertical wall portion continuously formed on an outer periphery of the upper wall portion, and a seal flange portion continuously projecting outward from an outer periphery of the vertical wall portion and attached to the housing, and
a natural frequency of the cover is shifted from a resonance point with vibromotive force of the compression mechanism and the motor by adjusting a curvature radius of an arch forming a shell shape of the upper wall and/or an angle at which the vertical wall portion rises from the seal flange portion.

2. The inverter-integrated electric compressor according to claim 1, wherein a curvature radius of the arch of the cover is set to a different value in a longitudinal direction and a lateral direction.

3. The inverter-integrated electric compressor according to claim 2, wherein a curvature radius of the arch of the cover in the longitudinal direction is larger than a curvature radius of the arch in the lateral direction.

4. The inverter-integrated electric compressor according to claim 1, wherein the shell shape of the cover includes a plurality of arches having different curvature radii.

5. The inverter-integrated electric compressor according to claim 1, wherein an angle at which the vertical wall portion rises from the seal flange portion ranges from an angle of 30° to an angle of 75°, inclusive.

6. The inverter-integrated electric compressor according to claim 1, wherein a height dimension of the cover ranges from 8 mm to 20 mm, inclusive.

7. A method for manufacturing an inverter-integrated electric compressor including a metal housing in which a motor and a compression mechanism are built, an inverter that drives the motor, an inverter accommodating portion that is formed in the housing and accommodates the inverter, and a metal cover that closes the inverter accommodating portion, wherein
the cover is formed of a sheet metal having a shell-shaped upper wall portion, a vertical wall portion continuously formed on an outer periphery of the upper wall portion, and a seal flange portion continuously extending outward from an outer periphery of the vertical wall portion and attached to the housing, and
a natural frequency of the cover is shifted from a resonance point with vibromotive force of the compression mechanism and the motor by adjusting a curvature radius of an arch constituting a shell shape of the upper wall portion and/or an angle at which the vertical wall portion rises from the seal flange portion.
